(19) United States
(12) Patent Application Publication
(10) Pub. No.: US 2023/0026318 A1
(43) Pub. Date: Jan. 26, 2023

(54) ELECTROHYDROSTATIC SYSTEM WITH PRESSURE SENSOR

(71) Applicant: Moog GmbH, Böblingen (DE)

(72) Inventors: Sascha Dany, Detzem (DE); Sven Müller, Ralingen (DE); Kohlhaas Reiner, Osburg (DE)

(21) Appl. No.: 17/779,622

(22) PCT Filed: Nov. 18, 2020
(86) PCT No.: PCT/EP2020/082546

§ 371 Date: May 25, 2022

(30) Foreign Application Priority Data
Nov. 26, 2019 (DE) 10 2019 131 980.3

(51) Int. Cl. B30B 15/20; B30B 15/28; F15B 15/18; F15B 13/02; F15B 20/00

(52) U.S. Cl. CPC B30B 15/20; B30B 15/28; F15B 15/18; F15B 13/024; F15B 20/00; F15B 2211/20515

(57) ABSTRACT

The present invention relates to an electrohydrostatic system having a hydraulic cylinder comprising a first cylinder chamber and a second cylinder chamber. Furthermore, the electrohydrostatic system has a fluid hydraulic supply device for providing a hydraulic fluid, a fluid hydraulic motor pump unit, designed to provide a fluid hydraulic volume flow in order to move the hydraulic cylinder. A motor control device is designed to provide a rated current for an electrical drive of the fluid hydraulic motor pump unit. Moreover, the electrohydrostatic system has at least one fluid hydraulic safety valve, which on a first valve side is connected to one of the cylinder chambers of the hydraulic cylinder and on a second valve side is connected to the fluid hydraulic motor pump unit. The fluid hydraulic safety valve can be bridged via a bypass connection with a fixed orifice plate, wherein the bypass connection is connected to the first valve side and to the second valve side of the at least one fluid hydraulic safety valve. Moreover, the electrohydrostatic system has a pressure sensor that is connected to one of the cylinder chambers of the hydraulic cylinder. The pressure sensor is designed to detect a fluid hydraulic pressure on one of the cylinder chambers and, according to the detected fluid hydraulic pressure, to provide an enabling signal for the motor control device to provide the rated current for the electrical drive of the fluid hydraulic motor pump unit.

The present invention relates to an electrohydrostatic system for controlling the setup speed of a hydraulic cylinder, for example in a powder press, forging press and/or a forming press.

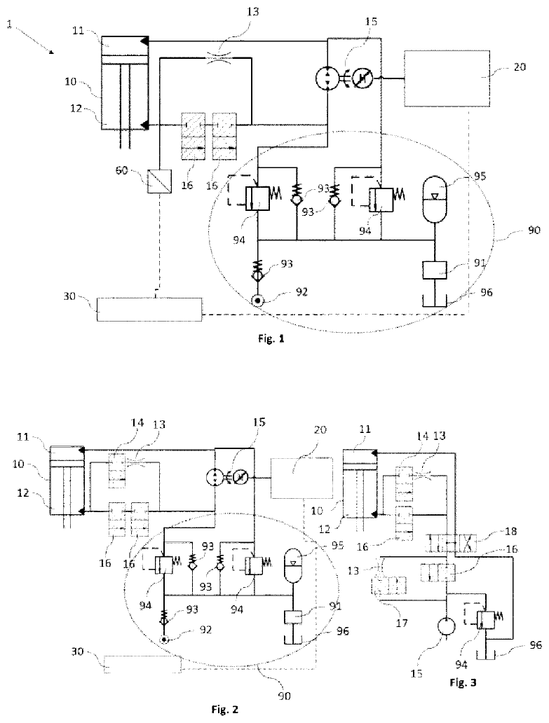

Systems for controlling the setup speed of hydraulic cylinders in presses are known in the art. FIGS. 2 and 3 show two systems known in the art for ensuring the setup speed.

FIG. 3 shows a classic hydraulic system, especially a constant pressure system. The constant pressure system comprises a constant pressure source 15 for supplying hydraulic pressure. Furthermore, the constant pressure system of FIG. 3 comprises directional valve 18 for controlling the function of the hydraulic cylinder 10, for example the retraction and extension. The certain setup speed is ensured by one or more fixed orifice plates 13, with or without a setup valve 14, 17. The fixed orifice plates 13 bridge one or two single or redundant safety valves 16 (load holding and/or pressure buildup valves). The fixed orifice plates 13 are set for the maximum pressure occurring in the system and/or to the suspended load on the hydraulic cylinder. In this case, a maximum pressure is throttled in the system via a fixed orifice plates 13 (parallel to the pressure buildup valves 16 behind the pump 15) before a pressure transmission can occur due to unequal surfaces in the hydraulic cylinder. In order to ensure the certain setup speed in the constant pressure system, a plurality of directional valves must be bypassed. First, the safety valve 16, which is connected between the directional valve 18 and the pump 15, must be bypassed. The safety valve 16 separates the pressure buildup of the pump 15 from the constant pressure system, in order to prevent a pressure buildup in the system. A second safety valve 16 is introduced between the suspended load on the ring side or the piston side of the hydraulic cylinder 10 and the directional valve 18. The safety valve 16 protects the hydraulic cylinder from falling down due to the suspended load. For a movement of the hydraulic cylinder, it is necessary to bridge these two safety valves or to open them accordingly. In setup mode and with the necessary bridging of the safety valve 16, the certain setup speed must still be ensured. The movement of the hydraulic cylinder must not exceed a speed of 10 mm/s, for example. For this purpose, the first safety valve 16 is bypassed for ensuring the hydraulic pressure in the constant pressure system via the parallel branch with the setup valve 17 or without a setup valve 17 and the fixed orifice plate 13. The fixed orifice plate 13 is designed in such a way that, at a maximum pressure of the pump 15, the volume flow that runs across the fixed orifice plate 13 does not reach a higher speed than, for example, 10 mm/s on the hydraulic cylinder. The fixed orifice plate 13 is thus designed for the maximum pressure of the pump 15. For the method of the hydraulic cylinder, the volume flow can be provided via the setup valve 17 and the fixed orifice plate 13 and can be directed via the directional valve 18.

In a further case, the suspended load on the ring side or piston side of the hydraulic cylinder can move the hydraulic cylinder. The suspended load and the hydraulic cylinder surface together generate a certain pressure on the load side of the hydraulic cylinder. By closing the safety valve 16, the volume flow runs through the setup valve 14 and the fixed orifice plate 13. The fixed orifice plate 13 is designed in such a way that, when the pressure is being applied by the suspended load on the ring side, the volume flow does not reach a speed higher than 10 mm/s.

Thus, the pump 15, which is protected via the safety valve 16 upstream of the directional valve 18, via the setup valve 17 and the fixed orifice plate 13, and the suspended load, which is protected via the safety valve 16, setup valve 14 and the fixed orifice plate 13, are the two sources that can provide power and thus a pressure buildup for the constant pressure system.

In the electrohydrostatic actuator system shown in FIG. 2, a securing of the setup speed can be set via a “safe limited speed” (SLS) function in the motor control device 20 and the drive motor of the motor pump unit 15 or, on the other hand, via a fixed orifice plate 13, with or without additional setup valve 14. In the illustrated electrohydrostatic actuator system, the energy input is again carried out via two types of energy, as already shown in FIG. 3. The pressure buildup is accomplished via the motor pump unit 15. The protection against pressure buildup in the event of a fault by the pump 15, which was achieved in the constant pressure system via safety valves and fixed orifice plates, is achieved in this system in the connected motor control device 20 by the function “safe torque off” (STO). As a result of this function, the motor to control device cannot provide power for the motor pump unit 15 for generating hydraulic power in the hydraulic system. In order to nevertheless be able to process the hydraulic cylinder, a volume flow must be supplied to the system. The volume flow can be realized only by the motor control device 20 having a function that limits the speed of the motor pump unit 15 to a predetermined value, for example to a value for a speed of 10 mm/s. This function corresponds to the aforementioned SLS function. The SLS function represents a special function in the motor control device 20. Rather, a safety-related motor control device 20 is required. The SLS function is cost-intensive and requires computing capacity. The motor control device can provide a specific computing power, which is limited by the installed hardware. A large part of the available computing power is reserved for the SLS function. Conversely, a necessary regulation can no longer be provided by the motor control device and further components are necessary, which increases the complexity of the control and additionally the costs.

In the further case, a securing according to the securing shown in FIG. 2 is carried out for the second energy input by means of the suspended load. The suspended load acts here on the second cylinder chamber 12. The securing is carried out via the safety valve 16 or the safety valves 16, which correspondingly block the hydraulic cylinder 10, whereby the volume flow runs through the setup valve 14 and the fixed orifice plate 13. The fixed orifice plate 13 is set to the pressure of the suspended load. A possible drop in the hydraulic cylinder via the suspended load is thus set via the fixed orifice plate 13. The hydraulic cylinder is moved by the SLS function and via the fixed orifice plate 13. The fixed orifice plate 13 no longer needs to be designed for this movement. This is designed only for the movement by the suspended load.

A disadvantage of the systems shown in FIGS. 2 and 3 is that the SLS function is necessary in the electrohydrostatic actuator system, which is cost-intensive and which reserves a large part of the computing power provided by the motor control device, whereby further functions can only be executed to a limited extent or not at all. The concept of the classic hydraulic system cannot be used for an electrohydrostatic system, as is provided in the present invention, because the energy input into the system is effected by the pump 15. In order to design the classic hydraulic system electrohydrostatically, extensive changes would have to be made, which make the system inefficient and cost-intensive. For such a design, a corresponding safety valve and a corresponding bypass valve with a fixed orifice plate would have to be provided in the branch from the pump to the piston chamber 11 of the hydraulic cylinder 10. This has the technical disadvantage that a large piston surface is produced, whereby the valves have to be designed to be correspondingly large and thus are very expensive and the corresponding adaptation is economically unviable. The fixed orifice plate would have to be designed such that the pressure at the fixed orifice plate would correspond to the maximum pressure of the motor pump unit. As a rule, the motor pump unit has a pressure of 350 bar. In this regard, the fixed orifice plate would have to be designed for a very high pressure level and thus for a very high energy level, wherein the suspended load is in a pressure range from 10 bar to 20 bar. Due to the necessary design for a higher pressure, extreme losses in the system would be generated, for example, and thus energy would be destroyed.

Therefore, there is a need for a mechanism for providing an ensured setup speed. Starting from the indicated prior art and the resulting need, the present invention has the object of providing a solution that at least partially overcomes the known disadvantages in the prior art.

A first aspect of the present invention comprises an inventive electrohydrostatic system having a hydraulic cylinder. The hydraulic cylinder has a first cylinder chamber and a second cylinder chamber. Furthermore, the electrohydrostatic system comprises a fluid hydraulic supply device for providing a hydraulic fluid and a fluid hydraulic motor pump unit. The fluid hydraulic motor pump unit is designed to provide a fluid hydraulic volume flow for moving the hydraulic cylinder. In addition, the electrohydrostatic system comprises a motor control device. The motor control device is designed to provide a rated current for an electric drive of the fluid hydraulic motor pump unit. Furthermore, the electrohydrostatic system is connected at least to one fluid hydraulic safety valve that is connected to one of the cylinder chambers or the second cylinder chamber of the hydraulic cylinder on a first valve side and to the fluid hydraulic motor pump unit on a second valve side. Furthermore, the electrohydrostatic system has a bypass connection with a fixed orifice plate for bridging the at least one fluid hydraulic safety valve. The bypass connection is connected to the first valve side and to the second valve side of the at least one fluid hydraulic safety valve. Furthermore, the electrohydrostatic system has a pressure sensor. The pressure sensor is connected to one of the cylinder chambers of the hydraulic cylinder, for example to the second cylinder chamber, and is designed to detect a fluid hydraulic pressure on one of the cylinder chambers and, according to the detected fluid hydraulic pressure, to provide an enabling signal for the motor control device to provide the rated current for the electrical drive of the fluid hydraulic motor pump unit.

The present invention is therefore based on the knowledge that the motor control device for controlling the motor pump unit requires only the STO function, which prevents the introduction of energy into the system. The SLS function of the motor control device is no longer required in the inventive embodiment of the electrohydrostatic system, whereby the setup speed is also not detected/monitored via the motor control device. In addition, the suspended load is protected by means of at least one safety valve and a fixed orifice plate. Advantageously, a pressure sensor is provided, for example on the ring side, which sensor determines the pressure on the ring side for further processing. The pressure on the fixed orifice plate is advantageously detected via the pressure sensor. If the pressure on the ring side rises above the pressure for which the fixed orifice plate is designed, a corresponding signal is evaluated and a corresponding control of the motor pump unit is carried out via the motor control device. The electrohydrostatic system can be stopped as a result of the detected pressure rise. In the embodiment according to the invention, the suspended load is thus also protected via the fixed orifice plate, plus for a certain pressure. For example, the minimum dimension that is secured includes the pressure (energy) that is inserted via the suspended load and a corresponding reserve, for example 20 bar. Accordingly, the evaluation of the pressure sensor must be set to the selected pressure. If the pressure at the fixed orifice plate rises above a corresponding value, that can include an increase in the speed of the hydraulic cylinder above a defined value, as a result of which the energy input into the motor pump unit is switched off via the STO function of the motor control device.

Further advantageous embodiments of the invention are the subject matter of the dependent claims and of the exemplary embodiments described below.

In one embodiment, the electrohydrostatic system comprises especially a first safety device, which is designed to receive an electrical signal corresponding to a detected fluid hydraulic pressure from the pressure sensor and to provide an enabling signal for the motor control device to provide the rated current for the electrical drive of the fluid hydraulic motor pump unit. The pressure can advantageously be detected via the pressure sensor. The pressure sensor is monitored by the first safety device. In one embodiment, the first safety device can be designed as a safety PLC (programmable logic controller), especially as a safety controller. The pressure sensor or the value of the determined pressure is read out via the first safety device, which monitors whether the system is still in safe setup mode. The safety device can further be used to address the motor control device; the STO function, especially, can be controlled.

In a further embodiment, the hydraulic cylinder is designed as a differential cylinder, synchronous cylinder, multi-surface cylinder or as a detached cylinder arrangement. In an advantageous manner, the electrohydrostatic hydrostatic system according to the invention can be used accordingly to address different hydraulic cylinders.

In a further embodiment, the fluid hydraulic supply device comprises a pressure accumulator, a safety valve, a fluid source, at least one check valve and a fluid reservoir. The fluid for the motor pump unit is partially provided via the fluid hydraulic supply device. The pressure accumulator represents a storage device of pressurized fluid that can be delivered into the system. The fluid reservoir represents a tank for the auxiliary unit from which the fluid source can also be supplied.

In a further embodiment, a safe torque off safety function is provided via the motor control device. The motor control device can be designed as a frequency converter. The frequency converter can be designed as a power converter that generates an alternating voltage from an AC voltage that can be varied in frequency and amplitude for directly supplying the motor pump unit.

The safe torque off (STO) function is a safety function integrated into the drive of the frequency converter. The STO function ensures that no torque-forming energy can act any longer on a motor, especially on the motor pump unit, and prevents an undesired start-up. The STO function is a device for preventing unexpected startup in accordance with EN 60204-1 para. 5.4. The STO function allows the pulses of a drive to be reliably erased. The drive is ensured to be torque-free. This state can be monitored internally.

In a further embodiment, the pressure sensor is designed as a pressure sensor with increased functional safety. The pressure sensor with increased functional safety is a pressure sensor specially designed for use in safety circuits/safety functions within the framework of functional safety of machines and systems up to PL d-Cat 3 (in accordance with ISO 13849). The pressure sensor with increased functional safety is designed in two channels, wherein each channel consists of a sensor element and evaluation electronics unit. Due to the redundant design, the pressure sensor generates two separate, mutually independent, pressure-proportional output signals with increased functional safety. The output signal is thus available in redundant form. Should a signal fail, a second signal is still available for processing, wherein the failure of a signal already initializes an error treatment. A check of safety function, along with error handling, can be performed by evaluating and comparing the two analog output signals in a first safety device. Via the first safety device and via the pressure sensor with increased functional safety, there is an indirect check of whether or not the setup speed of the hydraulic cylinder is exceeded. If the pressure rises above a certain value, a control signal is provided via the first safety device to the frequency converter for switching off the motor pump unit.

In an alternative embodiment, a redundant arrangement with two parallel simple pressure sensors can be provided, which sensors reflect the requirement for a pressure sensor with increased functional safety. Thus, these represent a pressure sensor arrangement with increased functional safety. Conventional or available pressure sensors can be used as pressure sensors for the pressure sensor arrangement.

In a further embodiment, the resistance of the fixed orifice plate has at least one value that is determined by pressure generated by a suspended load of the hydraulic cylinder. In the embodiment according to the invention, the suspended load is thus also protected via the fixed orifice plate. The safe setup speed is ensured. The fixed orifice plate can be designed for the pressure generated by the suspended load plus for a certain pressure.

In a further embodiment, the resistance of the fixed orifice plate to a pressure for providing a setup speed of the hydraulic cylinder is set in a range from 5 to 40 mm/s, preferably from 10 mm/s. As a result of this set pressure, set-up speeds evaluated as “safe” can be ensured according to the standard.

In a further embodiment, the pressure sensor is connected to the second cylinder chamber of the hydraulic cylinder. This arrangement can be necessary, depending on the cylinder arrangement as shown above, maximum pressure of the individual cylinder chambers, surface ratios on the cylinders, and energy limitations in the setup mode.

In a further embodiment, a fluid hydraulic setup valve is connected in the bypass connection. The setup mode can advantageously be switched on or off via this setup valve. In addition, this setup valve protects the cylinder from falling off due to its own weight and the attractive force when the motor pump unit is switched off.

In a further embodiment, a pressure relief valve is connected in the bypass connection. The setup valve can be replaced by the pressure relief valve in combination with a check valve. In addition, the pressure relief valve can be used to set the movement direction for which the setup speed is to be set. In the embodiment, the pressure relief valve can be used as a load holding valve in order to switch off a movement of the cylinder by its own weight and the attractive force. In a further embodiment, the pressure relief valve can be subjected to excess pressure in a targeted manner.

In a further embodiment, a check valve is connected in parallel with the pressure relief valve. A setup valve can be replaced/saved by means of the check valve in combination with the pressure relief valve. In addition, during the extension of the hydraulic cylinder in combination with the throttle valve, the check valve enables the load holding and the limited setup speed. During the retraction of the hydraulic cylinder, the pressure relief valve is bypassed via the branch of the check valve and the limited setup speed is likewise achieved.

In a further embodiment, the electrohydrostatic system comprises a second safety device comprising a distance measuring system and/or a mechanical safety. In combination with the first safety device, the second safety device forms a redundant safety device. Should one of the two safety devices have a defect, the remaining safety device can ensure the full safety of the system. Alternatively, the second safety device can also be designed as a second hydraulic safety valve. The second safety device can especially correspond to the first safety device. Alternatively to the pressure sensor, the distance measuring system can provide information about the actual speed of the hydraulic cylinder. The speed determined via the distance measurement system can then be used for limiting the same via the motor control device and the motor pump unit. In the pressure sensor with increased functional safety, a determination is made about the volume flow and, thus, the speed of the hydraulic cylinder via the determined pressure in combination with the defined resistance of the fixed orifice plate. In the distance measuring system, the speed of the hydraulic cylinder is determined via the path signal taking into account the time. A mechanical brake and/or a clamping device can be provided as a mechanical safety, for example.

In a further embodiment, the first cylinder chamber of the hydraulic cylinder is connected to the fluid hydraulic motor pump unit, and the second cylinder chamber of the hydraulic cylinder is connected to the at least one fluid hydraulic safety valve. In a further embodiment, the first cylinder chamber of the hydraulic cylinder is connected to the at least one fluid hydraulic safety valve, and the second cylinder chamber of the hydraulic cylinder is connected to the fluid hydraulic motor pump unit. The exact position for introducing the pressure sensor into the system is dependent on the design of the overall system. It is especially dependent on the orientation and the type of the hydraulic cylinder used, along with further axles that can exert excess pressure on the inserted axle and/or the weight force.

A second aspect of the present invention comprises the use of the electrohydrostatic system according to the invention for controlling the setup speed of a hydraulic cylinder in a powder press, forging press and/or forming press.

The invention is explained in the following on the basis of various embodiments, wherein it is pointed out that these examples also include modifications or additions as would be apparent to a person skilled in the art. Moreover, these preferred exemplary embodiments are not a limitation of the invention in that modifications and additions are within the scope of the present invention.

In the figures of the drawing, identical, functionally identical, and identically acting elements, features and components are respectively provided with the same reference signs, insofar as is not stated otherwise.

The following are shown:

FIG. 1 is a schematic representation of an electrohydrostatic system according to a first embodiment;

FIG. 2 is a schematic representation of a known electrohydrostatic system from the prior art;

FIG. 3 is a schematic representation of a classic hydraulic system known in the art;

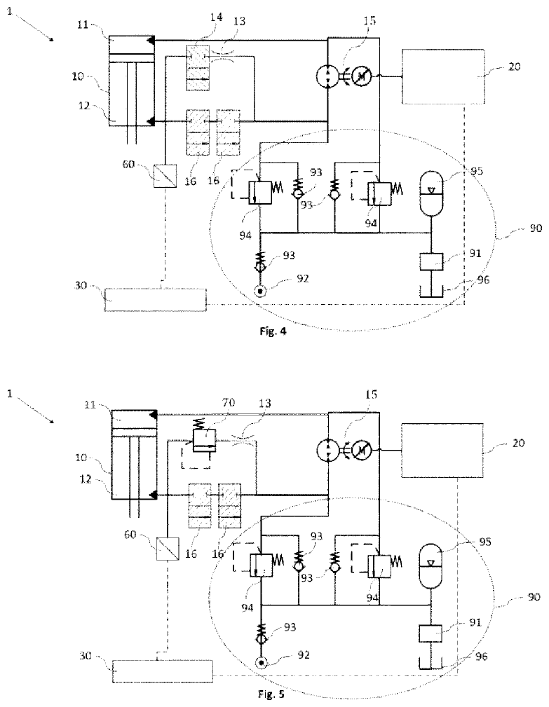

FIG. 4 is a schematic representation of an extrusion press with an electrohydrostatic system according to a second embodiment;

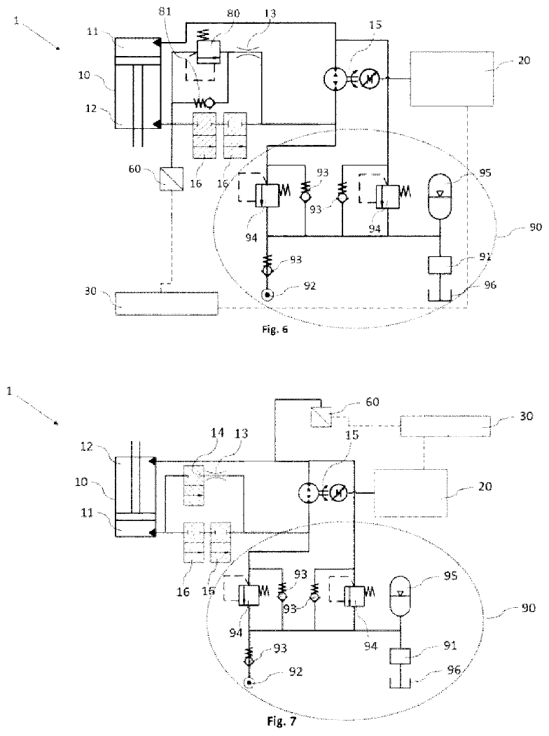

FIG. 5 is a schematic representation of an electrohydrostatic system according to a third embodiment;

FIG. 6 is a schematic representation of an electrohydrostatic system according to a fourth embodiment;

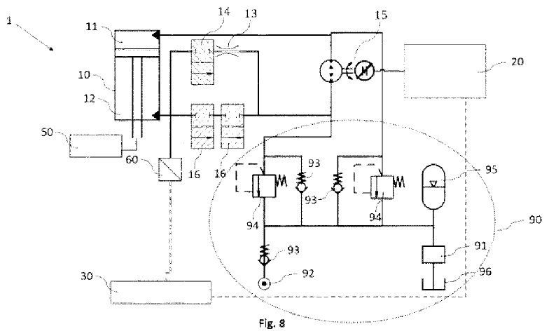

FIG. 7 is a schematic representation of an electrohydrostatic system according to a fifth embodiment;

FIG. 8 is a schematic representation of an electrohydrostatic system according to a sixth embodiment;

FIG. 1 shows a schematic representation of an electrohydrostatic system 1 according to a first embodiment. The electrohydrostatic system 1 has a hydraulic cylinder 10 with a first cylinder chamber 11 and a second cylinder chamber 12. Furthermore, the electrohydrostatic system 1 has a motor pump unit 15 for the pressure supply and a supply device 90 for fluid supply. The motor pump unit 15 is connected to the first cylinder chamber 11 of the hydraulic cylinder 10 and the supply device 90 via a check valve 93 at a first terminal in the embodiment shown in FIG. 1. At a second connection, the motor pump unit 15 has a connection to a safety valve 16, which is in turn connected to the second cylinder chamber 12 of the hydraulic cylinder 10. The supply device 90 comprises a safety valve 91, a fluid source 92, a check valve 93, a pressure accumulator 95 and a fluid reservoir 96. Furthermore, the electrohydrostatic system 1 has a motor control device 20 that can be designed as a frequency converter. In addition, the electrohydrostatic system 1 has a pressure sensor 60, especially a pressure sensor with increased functional safety. The pressure sensor 60 provides a pressure value of a first safety device 30 determined at the fixed orifice plate 13, preferably a safety PLC, as a safety control 30. The first safety device 30 is electrically coupled to the motor controller 20 and is designed to receive an electrical signal from the safety device 30 in response to an increased pressure corresponding to a setup speed outside the requirement. Preferably, the frequency converter 20 has a “safe torque off” (STO) function for switching off the torque of the motor pump unit in order to set the setup speed according to the requirements. The present invention is characterized by the pressure sensor with increased functional safety. Alternatively, two pressure sensors of simple design can be used in redundant combination, with which an evaluation of the provided signals is analogous to the pressure sensor with increased functional safety. Alternatively, a pressure sensor of simple design without a redundant design can be used and evaluated. The pressure sensors 60 in the embodiment, and in the alternative embodiment as shown above, can be introduced into the electrohydrostatic system 1 on the first cylinder chamber 11 and/or the second cylinder chamber 12 of the hydraulic cylinder 10. The hydraulic cylinder 10 can be used as a differential cylinder, synchronous cylinder, multi-surface cylinder or as a detached cylinder arrangement. Unintentional pressure buildup in the electrohydrostatic system 1 can be secured via the STO safety function of the frequency converter 20 and the motor pump unit 15. The protection against the suspended load dropping can be ensured by one safety-relevant valve or a plurality of safety-relevant valves 16. The setting of the safe speed in the setup process is carried out via the fixed orifice plate 13. The fixed orifice plate 13 represents a bypass of the safety valve 16 and is connected to the second cylinder chamber 12 of the hydraulic cylinder 10 and the motor pump unit 15 or the supply device 90. Furthermore, the fixed orifice plate 13 has a connection to the pressure sensor 60 with increased functional safety. In the embodiment of FIG. 1, the fixed orifice plate 13 is designed without an additional setup valve. The pressure difference for which the fixed orifice plate 13 is designed is set by the pressure sensor 60 with increased functional safety as the upper limit in setup mode. If this defined pressure value is exceeded, the first safety device 30 triggers the STO safety function of the frequency converter 20. By triggering of the STO safety function, the safe setup speed is not exceeded. With the embodiment according to the invention, a safe setup speed can be realized, although pressure differences occurring on the hydraulic chambers prevail due to unequal surfaces or other reasons. Thus, no pressure limiting device is subjected to excess pressure and the maximum set-up speed is limited. The setup speed is predetermined by the rotational speed and/or the delivery volume of the variable-speed motor pump unit 15, wherein the maximum setup speed can be freely defined by the resistance and the pressure sensor 60 with increased functional safety between the pressure of the suspended load and the maximum pressure of the pressure relief valves.

FIG. 4 shows a schematic representation of an electrohydrostatic system 1 according to a second embodiment. In the embodiment according to FIG. 4, the electrohydrostatic system 1 is expanded by a setup valve 14 in the bypass connection of the safety valve 16 or the safety valves 16 with reference to the embodiment of FIG. 1. The setup valve 14 is introduced between the fixed orifice plate 13 and the second cylinder chamber 12 of the hydraulic cylinder 10. The pressure sensor 60 with increased functionality determines the pressure at the fixed orifice plate 13 via the setup valve 14. Setup mode can be switched on or off via setup valve 14. In addition, a sagging of the hydraulic cylinder due to its own weight can be prevented in the event of failure of the motor pump unit 15.

FIG. 5 shows a schematic representation of an electrohydrostatic system 1 according to a third embodiment. In the embodiment according to FIG. 5, the electrohydrostatic system 1 is expanded by a pressure relief valve 70 in the bypass connection of the safety valve 16 or the safety valves 16 with reference to the embodiment of FIG. 1. The pressure relief valve 70 is introduced between the fixed orifice plate 13 and the second cylinder chamber 12 of the hydraulic cylinder 10. The pressure sensor 60 with increased functionality determines the pressure at the fixed orifice plate 13 via the pressure relief valve 70. The pressure relief valve 70 serves as a load holding valve in order to prevent a lowering of the piston of the hydraulic cylinder 10 due to the dead weight. A setup in the extending direction of the hydraulic cylinder 10 is made possible by the pressure relief valve 70.

FIG. 6 shows a schematic representation of an electrohydrostatic system 1 according to a fourth embodiment. In the embodiment according to FIG. 6, the electrohydrostatic system 1 is expanded by a pressure relief valve 80 in the bypass connection of the safety valve 16 or the safety valves 16 with reference to the embodiment of FIG. 1. The pressure relief valve 80 is introduced between the fixed orifice plate 13 and the second cylinder chamber 12 of the hydraulic cylinder 10. The pressure sensor 60 with increased functionality determines the pressure at the fixed orifice plate 13 via the pressure relief valve 80. In addition, a check valve 81 is provided in a bypass connection to the pressure relief valve 80. The pressure relief valve 80 serves as a load holding valve in order to prevent a lowering of the piston of the hydraulic cylinder 10 due to the dead weight. The function of the setup valve 14 is replaced by the pressure holding valve 80 in combination with the check valve 81. The pressure relief valve 80 is set for the suspended load.

FIG. 7 shows a schematic representation of an electrohydrostatic system 1 according to a fifth embodiment. In the embodiment according to FIG. 7, the pressure sensor 60 is connected with increased functional safety to the cylinder chamber of the hydraulic cylinder 10, which has no connection to the safety valve 16. The exact position of the pressure sensor 60 with increased functionality can be selected in dependence on the overall system and thus the orientation and the type of the hydraulic cylinders, further axes that can apply excess pressure to these axes and/or the acting weight force. Thus, a safe setup speed for each system can be provided efficiently and flexibly.

FIG. 8 shows a schematic representation of an electrohydrostatic system 1 according to a sixth embodiment. In the embodiment according to FIG. 8, the electrohydrostatic system 1 additionally comprises a second safety device 50. The second safety device 50 can comprise a distance measuring system and/or a mechanical safety. A redundant safety can be provided by the second safety device 50 in combination with the first safety device 30. A defect of one of the two safety devices 30, 50 can be compensated by the other functional safety device 30, 50, thereby ensuring the full safety. Alternatively, the second safety device 50 can also be designed as a second hydraulic safety valve 16. As an alternative to the pressure sensor 60, the distance measuring system supplies information about the actual movement speed of the hydraulic cylinder 10 with increased functional safety. The determined actual movement speed can be used for limiting the same via the frequency converter 20 in combination with the motor pump unit 15. For determining the actual movement speed, the path signal is derived over time. The mechanical safety can be set up via a mechanical brake and/or clamping device. This increases the safety of the electrohydrostatic system 1.

### LIST OF REFERENCE SIGNS

1 Electrohydrostatic system
10 Hydraulic cylinder
11 First cylinder chamber
12 Second cylinder chamber
13 Fixed orifice plate
14 Setup valve
15 Motor pump unit
16 Safety valve
17 Setup valve
18 Directional valve
20 Motor control device
30 First safety device
50 Second safety device
60 Pressure sensor
70 Pressure relief valve
80 Pressure relief valve
81 Check valve
90 Supply device
91 Safety valve
92 Fluid source
93 Check valve
94 Pressure relief valve
95 Pressure accumulator
96 Fluid reservoir

1. An electrohydrostatic system comprising:
a hydraulic cylinder having a first cylinder chamber and a second cylinder chamber;
a fluid hydraulic supply device for providing a hydraulic fluid;
a fluid hydraulic motor pump unit designed to provide a fluid hydraulic volume flow in order to move the hydraulic cylinder;
a motor control device designed to provide a rated current for an electrical drive of the fluid hydraulic motor pump unit;
at least one fluid hydraulic safety valve, which on a first valve side is connected to one of the cylinder chambers of the hydraulic cylinder and on a second valve side is connected to the fluid hydraulic motor pump unit;
a bypass connection having a fixed orifice plate for bridging the at least one fluid hydraulic safety valve, wherein the bypass connection is connected to the first valve side and to the second valve side of the at least one fluid hydraulic safety valve;
a pressure sensor, which is connected to the second cylinder chamber of the hydraulic cylinder and is designed to detect a fluid hydraulic pressure on one of the cylinder chambers and, corresponding to the detected fluid hydraulic pressure, to provide an enabling signal for the motor control device to provide the rated current for the electrical drive of the fluid hydraulic motor pump unit; and
the resistance of the fixed orifice plate having at least one value that in the hydraulic cylinder is determined by pressure generated by a suspended load of the hydraulic cylinder.

2. The electrohydrostatic system according to claim 1, wherein the electrohydrostatic system comprises a first safety device that is designed to receive an electrical signal corresponding to a detected fluid hydraulic pressure from the pressure sensor and to provide an enabling signal for the motor control device to provide the rated current for the electrical drive of the fluid hydraulic motor pump unit.

3. The electrohydrostatic system according to claim 1, wherein the hydraulic cylinder is designed as a differential cylinder, synchronous cylinder, multi-surface cylinder or a detached cylinder arrangement.

4. The electrohydrostatic system according to claim 1, wherein the fluid hydraulic supply device comprises a pressure accumulator, a safety valve, a fluid source, at least one check valve and a fluid reservoir.

5. The electrohydrostatic system according to claim 1, wherein the motor control device provides a safe torque off safety function.

6. The electrohydrostatic system according to claim 1, wherein the pressure sensor is designed as a pressure sensor with increased functional safety.

7. (canceled)

8. The electrohydrostatic system according to claim 1, wherein the resistance of the fixed orifice plate to a pressure for providing a setup speed of the hydraulic cylinder is set in a range from 5 to 40 mm/s.

9. The electrohydrostatic system according to claim 1, wherein the pressure sensor is connected to the second cylinder chamber of the hydraulic cylinder.

10. The electrohydrostatic system according to claim 1, wherein a fluid hydraulic setup valve is switched in the bypass connection.

11. The electrohydrostatic system according to claim 1, wherein a pressure relief valve is connected in the bypass connection.

12. The electrohydrostatic system according to claim 11, wherein a check valve is connected in parallel to the pressure relief valve.

13. The electrohydrostatic system according to claim 1, wherein the electrohydrostatic system comprises a second safety device that includes a distance measuring system and/or a mechanical safety.

14. The electrohydrostatic system according to claim 1, wherein the first cylinder chamber of the hydraulic cylinder with the fluid hydraulic motor pump unit and the second cylinder chamber of the hydraulic cylinder is connected to the at least one fluid hydraulic safety valve.

15. The electrohydrostatic system according to claim 1, wherein the first cylinder chamber of the hydraulic cylinder is connected to the at least one fluid hydraulic safety valve and the second cylinder chamber of the hydraulic cylinder is connected to the fluid hydraulic motor pump unit.

16. The electrohydrostatic system according to claim 1 for controlling the setup speed in a powder press, forging press and/or forming press.

17. The electrohydrostatic system according to claim 1, wherein the resistance of the fixed orifice plate to a pressure for providing a setup speed of the hydraulic cylinder is set at or below 10 mm/s.
